(19) United States
(12) Patent Application Publication
(10) Pub. No.: US 2022/0001218 A1
(43) Pub. Date: Jan. 6, 2022

(54) INSULATING BREATHER

(71) Applicant: DEZEGA HOLDING UKRAINE, LLC, Kyiv (UA)

(72) Inventor: Volodymyr Mykolalovych Popov, Kyiv (UA)

(21) Appl. No.: 17/292,992

(22) PCT Filed: Nov. 19, 2019
(86) PCT No.: PCT/UA2019/000144

§ 371 Date: May 11, 2021

(30) Foreign Application Priority Data
Nov. 23, 2018 (UA) A 2018 11550

(51) Int. Cl. A62B 9/00; A62B 19/00; A62B 7/02; A62B 18/10

(52) U.S. Cl. CPC A62B 9/003; A62B 18/10; A62B 7/02; A62B 19/00

(57) ABSTRACT

The invention relates to the respiratory organs protection technical means that provide human with life support in the atmosphere unsuitable for breathing. Insulating breather with closed breathing mixture circulation loop (self-contained self-rescue, SCSR) is equipped with a cylinder (15) containing pressurized oxygen. The breather has increased effectiveness of the treatment of the exhaled gas mixture and improved quality of the inhaling gas mixture by using the breathing mixture circulation loop of the present invention and using means for simultaneous mechanical pressing on the breath-out bag (4) and the breath-in bag (8) and the additional cooling.

### FIELD OF THE INVENTION

The invention relates to the respiratory organs protection technical means providing human with life activity in the atmosphere that is not suitable for breathing and relates to the insulating breather with a breathing mixture circulation closed loop (self-contained self-rescue, SCSR) equipped with a reservoir containing pressurized oxygen.

### BACKGROUND OF THE PRIOR ART

The breathers are necessary means during repair work and salvage in the different fields. The requirements for the quality and reliability of the breathers for ensuring users safety, as well as for their functionality and ergonomics are continuously increased and the planners and producers, therefore, make significant efforts for developing and improving different systems and units of the said articles.

The subject matter of this invention relates to the constitution and embodiment of the components of the breathing mixture circulation loop.

The numerous technical solutions directed to an improvement of a treatment of the gas mixture being breathed out by the user and to its preparation for breathing in by the user are known from the prior art.

So, British application GB 201516077 (IPC: A62B 9/00, published on Sep. 10, 2015) discloses a breather in the closed casing of which there are the breathing mixture circulation closed loop components connected to each other in series (in the flow direction): device for attaching a facial mask, the absorbing cartridge, counterlung and cooler. In case of such design, a gas mixture being breathed out by the user enters directly to the absorbing cartridge. Although the modern absorbing cartridges have an improved structure, they resist, however, the flow of the gas mixture being breathed out by the user.

Furthermore, in case of such design of the described circulation loop. the absorbing cartridge treats significantly a variable flow of a mixture being breathed in as a result of which an active substance thereof has different absorption being decreased upon increase in velocity of washing the absorber grains by the gas mixture flow. A part of the breathing flow passes through the absorbing cartridge in the uncleaned form.

If the user breathes in, then the latter feels a difficulty being increased upon increase in physical activity and lung venting related thereto as the user must overcome a resistance being created by the cooler against the breathing mixture flow. Internet publication http://megapredmet.ru/1-22532.html describes the insulating breathers with circular air circulation circuit, wherein, in addition to the general counterlung located between the absorbing cartridge and cooler, there is an additional bag positioned between the exhalation valve and regenerating cartridge. Thus, bag serves for decreasing a resistance to a breath-out due to “smoothing” of the peak volume air flow. These breathers do not solve a problem of a possible breath-in of the toxic gases due to non-tight abutting of the mask on the user face.

The state of art discloses also popular Germanic insulating breather Drager PSS® BG 4 plus (Drager Safety AG & Co. Kgaa https://www.draeger.com/Products/Content/pss-bg4-plus-pi-9044832-us-en.pdf; 2009) in the casing of which ari absorbing cartridge and cooler are positioned directly near the breath-out branch pipe and breath-in branch pipe, respectively, as a result of which non-uniform flow of the gas mixture being treated is pumped through a cartridge.

A counterlung attached between the absorbing cartridge and cooler is equipped with a pressing device for creating an overpressure in the circuit that prevents entering of the polluted gases to the user respiratory tracts from the environmental atmosphere when the user breaths in. A condensate being obtained in the cooler is withdrawn to the collector through a counterlung drain valve. The pressing device is designed in such way that a mounting and removing of the counterlung with pressing system are complex.

DE102016000268 A1 (Drager Safety AG & Co. Kgaa; IPC:⋅ A62B 7/02, published on Jul. 20, 2017) discloses an elastic counterlung located between an absorbing cartridge and a cooler, the said counterlung being in the form of parallelepiped and having a pressing device designed as a pressing plate acting on the long edge being perpendicular to the stationary base of the counterlung, the long side of the said pressing plate being positioned on the rotational axis at a distance from the counterlung base.

Pressing is carried out by an actuator in the form of a spring. The spring can be mounted in such a way that it provides torsional action along the rotation axis or tensional action through different arm mechanisms.

The drawback of the above-mentioned breathers is that they are designed to deliver a gas mixture being breathed out directly to the absorbing cartridge that results in flowing of a mixture being breathed out through the cartridge that is substantially alternating during breathing cycle.

The object of the invention is to improve a quality of a breathing mixture in the insulating breather and to make a breathing more comfortable for the user of the said insulating breather by using the breathing mixture circulation loop of the present invention.

### SUMMARY OF THE INVENTION

The said object is solved by that, in the insulating breather comprising casing equipped with facial mask and attachment box with breath-in hose and breath-out hose, in which casing the system for treating and supplying a breathing mixture are located, the said system comprising breath-in bag and breath-out bag, the absorbing cartridge, the cooler, the system for supplying oxygen and forced breathing mixture circulation, the said system comprising the oxygen cylinder, oxygen distribution unit with gear box and device for permanent oxygen supply, and pulmonary automation connected to a medium pressure zone, as well as the device for creating an overpressure in the breathing mixture circulation loop; according to the invention, the closed breathing mixture circulation loop comprises the following components connected in series: breath-in hose, attachment box, facial mask, breath-out hose, exhalation valve, breath-out bag, absorbing cartridge, cooling separator, cooler, breath-in bag, inhalation valve, wherein the said separator includes the hollow cooling channel made of heat-conducting material, the said channel being in thermal contact with the breather casing for passing a hot breathing mixture from the absorbing cartridge to the cooler and the channel for withdrawing a counter-current flow of the condensate from the gas mixture cooler, the said channel being separated from the cooling channel, inhalation valve is arranged in the casing between the breath-in branch pipe and breath-in bag; exhalation valve is arranged in the casing between the breath-out bag and breath-out branch pipe; breath-in bag and breath-out bag are arranged in the upper part of the casing directly below the inhalation valve and exhalation valve, respectively; pulmonary automation output and output of the device for permanent oxygen supply are connected to the breath-in pipe after inhalation valve relative to the breathing mixture flow direction; device for creating an overpressure in the breathing mixture circulation loop comprises the pressing plate mounted for mechanically acting simultaneously on the breath-out bag and breath-in bag and on the pneumatic and mechanical feedback system related thereto, the said system comprising spring-loaded arm with variable pressing force depending on the breathing bags filling.

In the preferred embodiment of the invention, the cooling separator is designed as a bag made of elastic heat conducting material and equipped with input branch pipe and output branch pipe, the said branch pipes having flanges for attaching to the lower parts of the absorbing cartridge and cooler, respectively, wherein, in the lower part of the bag, there is a separation perforated partition below which a hygroscopic component for absorbing condensate from the cooler is located.

In the preferred embodiment of the invention, inhalation valve and exhalation valve are structurally identical and comprise plastic saddle and mushroom-like elastic leaf, wherein the saddle work surface is concave and is in the form of a fragment of the side surface of a cylinder.

### DESCRIPTION OF THE DRAWINGS

The features and advantages of the invention are further explained in more details in the examples of embodiment with reference to the drawings. The following is illustrated on them:

FIG. 1 is a schematic view of the insulating breather with closed breathing mixture circulation loop.

FIG. 2 is the cooling separator.

### DETAILED DESCRIPTION OF THE PREFERRED EMBODIMENT

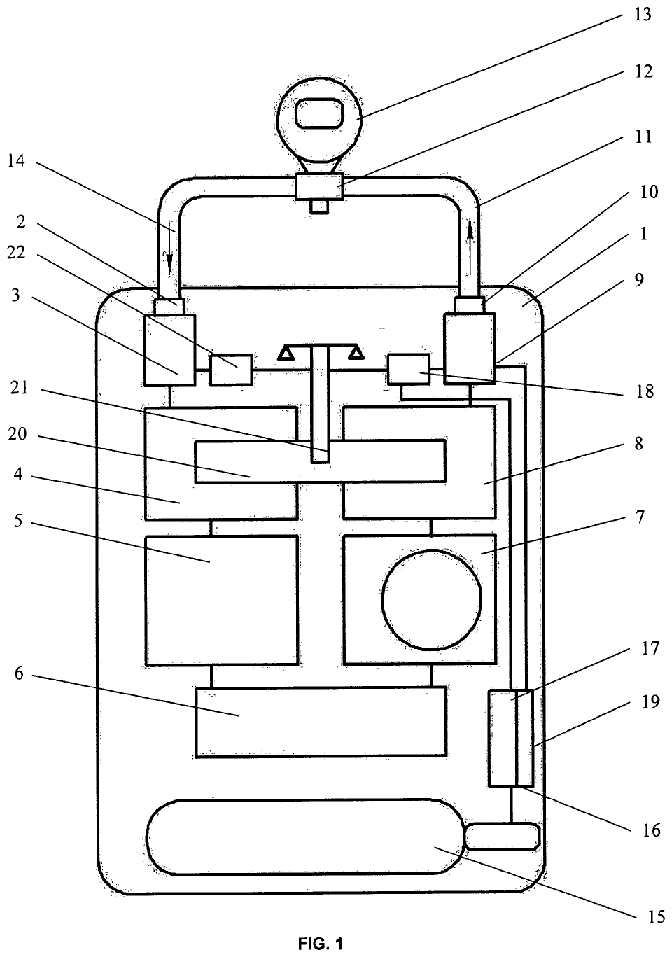

FIG. 1 shows a schematic view of the embodiment of the insulating breather of the present invention, the said breather comprising casing 1 in which the following components of the closed breathing loop are positioned and connected to each other in series in the direction of the gas mixture flow: breath-out branch pipe 2, exhalation valve 3, breath-out bag 4, absorbing cartridge 5, cooling separator 6, breathing mixture cooler 7 with a coolant in the form of solid bar or ice pieces contained in the cup, cooled gel etc., breath-in bag 8, inhalation valve 9, breath-in branch pipe 10, as well as hose system including flexible breath-in hose 11 attached to the breath-in branch pipe 10, communication box 12, facial mask 13 and flexible breath-out hose 14 attached to breath-out branch pipe 2.

Hose tips 11 and 14 together with the branch pipes 2 and 10 mounted in the casing constitute identical rotational attachment units allowing the hose tips to be rotated relative to the branch pipes, for example, if it is necessary to remove the breather from the shoulders and push it forward in the narrow horizontal channel Due to the rotation of the hose tips relative to the branch pipes, a risk of local bends of the hoses and stopping or deterioration of the breathing mixture flow is, otherwise, avoided.

In the lower part of the casing, there is a cylinder 15 containing pressurized oxygen and connected to the oxygen distribution unit 16 in which the gear box with medium pressure zone 17 is mounted, to which medium pressure zone the pulmonary automation 18 and device 19 for supplying permanent oxygen flow are connected.

In contrast to the prior art solutions, according to which the pulmonary automation output and the output of the device for supplying permanent oxygen flow are connected, as a rule, to the breath-in bag, according to the invention, the output of the pulmonary automation 18 and output of the device 19 for supplying permanent oxygen flow are connected to the breath-in branch pipe 10 after inhalation valve 9 relative to the direction of the breathing mixture flow. Such attachment is motivated by a necessity to eliminate so-called “dead space” that is formed in the hose system during breath-in due to at least partial filling of the communication box 12 and breath-in hose 11 with the breathing gas mixture. At the beginning of the next breath-in phase, the user breaths in a depleted gas mixture from this space and only then the breathing mixture treated in the absorbing cartridge and enriched with oxygen from the breath-in bag. Due to supplement of oxygen from the device 19 for supplying permanent flow after inhalation valve 9, the gas mixture enriched with oxygen permanently exists in the hose system as a result of which a protective function of the breather is increased as well as an additional “reason” for circulating a gas mixture in the loop is created.

According to the invention, the inhalation valve and exhalation valve are structurally identical and comprise each the plastic saddle and mushroom-like leaf, wherein the saddle work surface is concave and is in the form of a fragment of the side surface of a cylinder. This is performed in order to provide the uniform conditions of the leaf bending in the direction of the breathing mixture flow. Due to the concave surface of the saddle, the areas of the elastic leaf being bent when the breathing mixture is passed are unambiguously determined but not randomly. Furthermore, the more tight abutment of the leaf in the closed valve is provided.

Breath-out bag 4 and breath-in bag 8 are structurally located next to each other in the top part of the casing directly below the exhalation valve 3 and inhalation valve 9, respectively. The absorbing cartridge 5 is positioned directly below the breath-out bag 4 and the cooler 7 is positioned directly below the breath-in bag 8. The additional advantage of the positioning of the comparably heavy structural elements such as absorbing cartridge 5 and cooler 7 not in the top part of the casing is that the reduced center of mass of the breather is offset down.

The pressing plate 20 of the device provided for creating an overpressure in the breath-in section of the breathing mixture circulation loop as well as for equalizing pressure drop in the breath-out section of the circulation loop during user breathing is arranged directly above the breath-out bag 4 and breath-in bag 8.

The applicant has conducted a numerous laboratory researches and field investigations relating to a mutual arrangement and structure of the circulation loop components (absorbing cartridge, cooler, counterlung) that define a quality of the breathing mixture treatment and user comfort during breath-in phase and breath-out phase of the counterlung. In order to reduce the forces exerted by the user during breath-in and breath-out, the applicant has decided to refuse from the counterlung equipped with pressing device and included between the absorbing cartridge output and cooler input in favour of the separate breath-out bag 4 and breath-in bag 8 which are positioned at the input of the absorbing cartridge 5 and at the output of the cooler 7, respectively. Breath-in bag 8 is continuously pressed for creating an overpressure in the breath-in section of the circulation loop in order to avoid breath-in of the toxic environmental gases by the user due to possible non-tightness of abutting of the facial mask to the user face. The breath-out bag 4 is continuously pressed for smoothing pressure drop at the input of the absorbing cartridge 5 during breath-in phase in order to maintain a gas mixture flow being breath out as permanent as possible in it for providing optimal conditions for working active substance of the absorbing cartridge 5. The experiments relating to an independent pressing of the breath-in bag and breath-out bag have represented good results upon stationary breathing mode, however, when the breathing load is varied, a closed circulation loop disbalance happens: the breath-in bag and breath-out bag are inflated or folded depending on the change of the direction of the breathing intensity.

Therefore, according to the invention, breath-in bag 8 and breath-out bag 4 are simultaneously pressed by the pressing plate 20 that is pivotally mounted at the end of the spring-loaded arm 21 without tilt to the bag with lower pressure, the other end of the said plate being pivotally fixed on the casing 1. The shapes and linear ratio of the levers of arm 21, the points for attaching the lever and spring as well as a spring force range are chosen in calculation way and in the following empirical way so that when both bags are filled in and discharged upon user breathing, the ratio change of effective values of the arm levers ensures such change of the plate resulting pressing force that a reduction of resistance to breath-out is stably achieved at the end of the breath-out phase and in the significant breathing load range depending on the degree of the bags filling, a reduction of the resistance to breath-in, as well as, to a large degree, uniform flow through the absorbing cartridge 5 and cooler 7 during breath-out phase and breath-in phase, whereby the favorable conditions for working of an active substance of the absorbing cartridge 5 and for effective heat-exchange in the cooler 7 are provided.

When the breathing loop works; spring-loaded arm 21 also controls the safety valve 22 for releasing an excess breathing mixture volume that is connected to the breath-out branch pipe 2 in front of the exhalation valve 3 relative to the direction of the gas mixture flow in the breathing loop, as well as pulmonary automation 18. Two utmost breathing system conditions are possible depending on the user breathing intensity:

In the breath-out stage, if the general volume of the breathing mixture that is breathed out by the user into the breathing loop and of that present in the breathing loop exceeds the inner volume of the breathing loop, then breath-out bag 4 and breath-in bag 8 are inflated and act on the valve 22 releasing an excess of the breathing mixture being breathed out to the environment by means of the pressing plate 20 and pressing arm 21.

In the breath-in stage, when treated breathing mixture present in the breath-in bag 8 is insufficient for satisfying the user demand, the pressing plate 20 descends and spring-loaded pressing arm 21 acts on the pulmonary automation 18 that, in contrast to the prior art, supplies oxygen rather directly to the breath-in branch pipe 10 from the medium pressure⋅ zone 17 than to the breath-in bag 8 without delay satisfying a demand of the user in breathing mixture.

As the gas mixture has very high temperature at the output of the absorbing cartridge 5 that generally decreases in the cooler 8 with coolant, in order to additionally decrease the temperature of the breathing mixture being breathed in by the user, according to the invention, the communication component is used between the absorbing cartridge 5 and cooler 7. For this purpose, the closed breathing mixture circulation loop comprises the device of the present invention for supplying hot gas mixture from the output of the absorbing cartridge 5 to the cooler 7, for cooling it additionally and simultaneously withdrawing it with the counter-current condensate flow that is formed in the cooler (so called cooling separator 6).

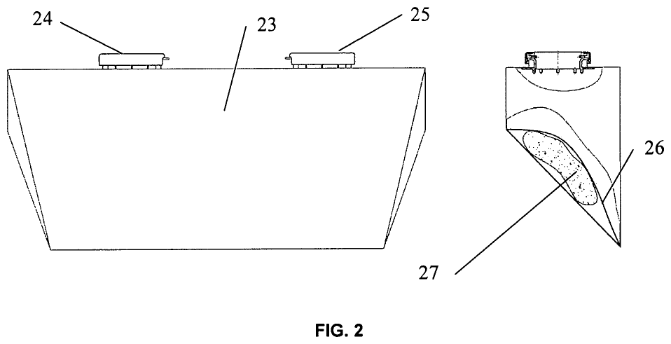

In the preferred embodiment of the invention, separator 6 (FIG. 2) is designed as a flexible bag 23 having input branch pipe 24 and output branch pipe 25 which are equipped with flanges for attaching to the lower parts of the absorbing cartridge 5 and cooler 7, respectively. The channel for separating hot breathing mixture flow from the absorbing cartridge 5 and condensate from the cooler 7 is formed by the output branch pipe 25 and the perforated separating partition 26 positioned along all length of the bag 6. The dehumidification component 27 is arranged in the lower part of the bag 23 of the separator 6 below the partition 26.

When the breathing loop works, the hot gas mixture flowing from the absorbing cartridge 5 enters cooler 7 through the cooling bag 23. At the same time, bag 23 is made to be filled in with the breathing mixture cleaned in the cartridge 5 and the walls thereof are pressed to the back cover of the casing 1 as well as to the cylinder 15, transferring a breathing mixture heat to them.

An additional decrease in temperature of the breathing mixture by several degrees is achieved by using cooling separator 6.

In the cooler 7, the hot gas mixture contacts cooled outer wall of the cup filled with coolant, is cooled down and enters breath-in bag 8. Condensate that is formed in the cooler 7 on the wall of the cup with coolant flows down through the output branch pipe 25 under the separating partition 26 and is collected in the dehumidification component 27.

The technical solutions of the present invention described above allows to treat more effectively a gas mixture being breathed out by the user of the insulating breather and to prepare, more qualitative, the breathing mixture being breathed in by the user within the wide range of the active breathing by effectively cooling it and rational enriching it with oxygen as well as to improve comfort of the user breathing by reducing a breathing loop resistance during different phases of breathing cycle.

The claimed technical solutions are used in the last models of the insulating breathers of the applicant.

### LIST OF THE REFERENCES

1 Casing
2 Breath-out branch pipe
3 Exhalation valve
4 Breath-out bag
5 Absorbing cartridge
6 Cooling separator
7 Breathing mixture cooler
8 Breath-in bag
9 Inhalation valve
10 Breath-in branch pipe
11 Breath-in hose
12 Communication box
13 Facial mask
14 Breath-out hose
15 Cylinder
16 Oxygen distribution unit
17 Medium pressure zone
18 Pulmonary automation
19 Device for permanent oxygen supply
20 Pressing plate
21 Spring-loaded arm
22 Overpressure relief valve
23 Separator bag
24 Input branch pipe
25 Output branch pipe
26 Separating partition
27 Dehumidification component

1. (canceled)

2. (canceled)

3. (canceled)

4. An insulating breather comprising a casing-backpack equipped with a facial mask and an attachment box having a breath-in hose and a breath-out hose, in which a system for treating and supplying a breathing mixture is located, said insulating breather comprising:
a breath-in bag and a breath-out bag, an absorbing cartridge, a breathing mixture cooler with a coolant, a system for supplying oxygen and circulating the breathing mixture in a forced manner, said system including an oxygen cylinder, an oxygen distribution unit comprising a gearbox and a device for permanent oxygen supply and a pulmonary automation connected to a medium pressure zone, as well as said device for creating an overpressure in a breathing mixture circulation loop; and
a closed breathing mixture circulation loop including said breath-in hose, said attachment box, said facial mask, said breath-out hose, an exhalation valve, said breath-out bag, said absorbing cartridge, a cooling separator, a breathing mixture cooler, said breath-in bag, said inhalation valve, wherein the said cooling separator comprises a hollow cooling channel made of a heat-conducting material and being in thermal contact with cold surfaces of said breather for passing the hot breathing mixture from said absorbing cartridge to said cooler and said channel for withdrawing counter-current condensate flow from said cooler and separated from said cooling channel, as well in that the said inhalation valve is arranged in said casing between said breath-in branch pipe and said breath-in bag and said exhalation valve is arranged in said casing between said breath-out bag and said breath-out branch pipe, as well in that said breath-in bag and said breath-out bag are arranged in said top part of the casing directly below said inhalation valve and said exhalation valve, respectively, as well in that output of said pulmonary automation and output of said device for permanent oxygen supply are connected to said breath-in branch pipe after said inhalation valve relative to the direction of said breathing mixture flow, as well in that said device for creating an overpressure in said breathing mixture circulation loop comprises a pressing plate mounted for simultaneously mechanically acting on said breath-out bag and said breath-in bag and on the pneumatic and mechanical feedback system related thereto comprising a spring-loaded arm with variable pressing force depending on the filling of said breath-out bag and said breath-in bag.

5. The insulating breather as set forth in claim 4, wherein said cooling separator is designed as a bag made of flexible heat-conducting material, said bag having an input branch pipe and an output branch pipe that equipped with flanges for attaching to the lower parts of said absorbing cartridge and cooler, respectively, wherein a separating perforated partition below which a hygroscopic component for absorbing condensate from said cooler is positioned is arranged in the lower part of said bag.

6. The insulating breather as set forth in claim 4, wherein said inhalation valve and said exhalation valve are structurally identical and each includes a plastic saddle and a mushroom-like elastic leaf, wherein said saddle presents a concave work surface in the form of a fragment of a side surface of cylinder.
